(19) United States
(12) Patent Application Publication
(10) Pub. No.: US 2026/0027546 A1
(43) Pub. Date: Jan. 29, 2026

(54) CARBON DIOXIDE SORBENTS

(71) Applicant: EXXONMOBIL TECHNOLOGY AND ENGINEERING COMPANY, Spring, TX (US)

(72) Inventors: Wesley SATTLER, Parsippany, NJ (US); Scott WEIGEL, Allentown, PA (US); Aaron PETERS, New Hope, PA (US); Keith HAJKOWSKI, Somerset, NJ (US); Nicole HERB, Allentown, PA (US); Rodrigo BLANCO GUTIERREZ, Berkeley Heights, NJ (US); James BIELENBERG, Lebanon, NJ (US)

(21) Appl. No.: 18/784,055

(22) Filed: Jul. 25, 2024

Related U.S. Application Data
(60) Provisional application No. 63/516,020, filed on Jul. 27, 2023.
(60) Provisional application No. 63/516,030, filed on Jul. 27, 2023.
(60) Provisional application No. 63/516,023, filed on Jul. 27, 2023.
(60) Provisional application No. 63/568,661, filed on Mar. 22, 2024.

(51) Int. Cl. B01J 20/26; B01J 20/18; B01J 20/28; B01J 20/32

(52) U.S. Cl. CPC B01J 20/262; B01J 20/183; B01J 20/28042; B01J 20/28061; B01J 20/28076; B01J 20/3204; B01J 20/3219; B01J 2220/82

(57) ABSTRACT

Sorbent materials are provided with selectivity for sorption of CO₂. The sorbent materials are formed by using a multi-dentate reagent to react with a relatively low molecular weight polyamine, such as a relatively low molecular weight polyethyleneimine (PEI). This forms a new modified polymer material that can be supported on a support material to provide a supported sorbent material. The amount of the multi-dentate reagent can be low enough so that only a reduced or minimized number of the nitrogen atoms in the polyamine are reacted during the cross-linking. The resulting modified polymer material can maintain the desirable sorption capacity of a lower molecular weight polyamine while having reduced volatility and/or while having and/or while still substantially maintaining a high CO₂ sorption capacity for the resulting supported modified polyamine material.

### CLAIMS-REFERENCE TO RELATED APPLICATIONS AND PRIORITY CLAIM

This Non-Provisional Patent application claims priority to U.S. Provisional Patent Application No. 63/516,020, filed Jul. 27, 2023, and titled “Carbon Dioxide Sorbents”. This application also claims priority to U.S. Provisional Patent Application No. 63/516,030 filed on Jul. 27, 2023, U.S. Provisional Patent Application No. 63/516,023 filed on Jul. 27, 2023, and U.S. Provisional Patent Application No. 63/568,661 filed on Mar. 22, 2024. The entire contents of each of the above documents is hereby incorporated by reference into the present application.

### FIELD OF THE INVENTION

Supported sorbent materials are provided with improved resistance to oxidation and decreased volatility, along with corresponding systems and methods for use of such materials.

### BACKGROUND OF THE INVENTION

One strategy for performing CO₂ capture is to perform a process cycle where CO₂ is first sorbed using a solid sorbent, and then desorbed in a subsequent part of the cycle. This can allow CO₂ to be selectively removed from a gas flow. A variety of amines have been previously investigated for potential use as sorbent materials for CO₂ capture.

One difficulty with using amines is balancing the various considerations that are desirable for a sorbent material. Preferably, a sorbent material can have a relatively low cost of manufacture, a high sorption capacity per weight/volume of the material, and a long operating lifetime before breakdown and/or degradation. It would be desirable to develop materials with improved combinations of these features.

U.S. Patent Application Publication 2012/0160097 describes epoxy-amine acid gas adsorption-desorption polymers and oligomers. The cross-linked materials are self-supported materials that are formed into a gel to allow for formation of particles that have a pore volume. The particles are then deposited on a planar substrate for use.

A journal article titled “Epoxy Cross-Linked Polyamine CO₂ Sorbents Enhanced via Hydrophobic Functionalization” (Chem Mater. Vol. 31, No. 13, p 4673, 2019) describes modification of polyethyleneimine with hydrophobic additives, such as 2-ethylhexyl glycidyl ether. The modified polyethyleneimine is then cross-linked using bisphenol-A diglycidyl ether to form a support-free sorbent material. These materials are shown to be able to tune adsorption efficiency, but do not take into account operating lifetime.

A journal article by Choi et al. titled “Epoxide-functionalization of polyethyleneimine for synthesis of stable carbon dioxide adsorbent in temperature swing adsorption” (Nat. Commun. 7:12640 doi: 10.1038/ncomms 12640 (2016)) describes assignment of primary, secondary, and tertiary amines using ¹³C NMR spectroscopy.

### SUMMARY

In an aspect, a supported modified polyamine material is provided. The material is formed by a process that includes mixing a polyamine comprising a weight average molecular weight of 500 Da to 5,000 Da with a multi-dentate linker having a plurality of epoxy groups, aldehyde groups, halide groups, isocyanate groups, or a combination thereof, in a solvent to form a modified polymer material. The polyamine and multi-dentate linker can be mixed in a molar ratio of monomer units of polyamine to multi-dentate linker of between 5.0 and 1000. Additionally, the method further includes supporting the modified polyamine material on a porous support to form a supported modified polyamine material. The supported modified polyamine material can have an equilibrium CO₂ capacity of 0.5 mmol CO₂/g polyamine or higher at 35° C. in the presence of 100 kPa CO₂.

### BRIEF DESCRIPTION OF THE DRAWINGS

FIG. 1 shows thermogravimetric analysis measurements of weight gain for supported polymer materials in the presence of CO₂.

FIG. 2 shows thermogravimetric analysis measurements of weight loss for supported polymer materials when exposed to various conditions.

FIG. 3 shows changes in CO₂ capacity over time during exposure of supported polymer materials to cyclic conditions for oxidation at 140° C. and CO₂ sorption.

FIG. 4 shows changes in CO₂ capacity over time during exposure of supported polymer materials to cyclic conditions for oxidation at 120° C. and CO₂ sorption.

FIG. 5 shows CO₂ breakthrough data for various unmodified and modified PEI samples.

FIG. 6 shows CO₂ sorption kinetics determined based on the breakthrough data shown in FIG. 5.

FIG. 7 shows assignment of primary, secondary, and tertiary amines in unmodified and modified PEI samples using ¹³C NMR.

### DETAILED DESCRIPTION

### Overview

In various aspects, sorbent materials are provided with selectivity for sorption of CO₂. The sorbent materials are formed by using a multi-dentate reagent to react with a relatively low molecular weight polyamine, such as a relatively low molecular weight polyethyleneimine (PEI). This forms a new modified polymer material that can be supported on a support material to provide a supported sorbent material. The multi-dentate reagent can correspond to, for example, a di-epoxy, a tri-epoxy, or another multi-dentate reagent that would be expected to have cross-linking activity with a polyamine. The amount of the multi-dentate reagent can be low enough so that only a reduced or minimized number of the nitrogen atoms in the polyamine are reacted during the cross-linking. Other examples of multi-dentate ligands can include, but are not limited to, multi-functional aldehydes (either with or without reductive amination), multi-functional halides, multi-functional isocyanates, and ligands including combinations of epoxies, aldehydes, halides, and/or isocyanates. The resulting modified polymer material can maintain the desirable sorption capacity of a lower molecular weight polyamine while having reduced volatility and/or increased resistance to oxidation. The reduced volatility and/or increased resistance to oxidation can allow the resulting modified polymer material to maintain capacity for sorption for longer periods of time. Additionally, by using a reduced or minimized amount of the multi-dentate reagent, the reduced volatility and/or increased resistance to oxidation can be achieved while still substantially maintaining a high CO₂ sorption capacity for the resulting supported modified polyamine material.

Selecting an amine-based material for sorption and desorption of CO₂ typically involves balancing a variety of factors. One type of material that would be desirable for CO₂ sorption/desorption is polyamines. A number of types of polyamine materials can be readily synthesized, providing a relatively low cost material with a high density of potential CO₂ sorption sites. However, a number of challenges remain with implementing such polyamines.

Some challenges are related to sorption capacity. For example, polyamines that correspond to polymeric amines provide a repeating structure that includes a potential CO₂ sorption site in each repeat unit, as the molecular weight of a polyamine increases, the sorption capacity of the polyamine tends to decrease. Thus, based on sorption capacity considerations, a lower molecular weight polyamine would be preferable.

Other challenges are related to stability of a polyamine sorbent system over an extended period. In order to increase availability of sorption sites, it is desirable to support a polyamine sorbent on a support with relatively high surface area. Examples of support materials can include high surface area refractory oxides (such as alumina) and/or zeotype supports. Unfortunately, as the molecular weight of a polyamine decreases, the volatility of the polyamine increases. Volatility is undesirable because it can lead to loss of polyamine from a support during normal operation, especially at the higher temperature parts of the process, which a sorbent is exposed to during the desorption step in a sorption/desorption cycle.

Additionally, polymers, especially polyamines, can also suffer from oxidation when exposed to oxygen. Many of the CO₂-containing gases where CO₂ removal is desirable can also contain oxygen, with the amount of oxygen possibly being substantially larger than the amount of CO₂ (e.g., air). While degradation of a polymer due to the presence of oxygen can be reduced or minimized by controlling the temperature during exposure to oxygen, improved resistance to oxidation would be desirable to increase the run lengths for a sorbent system while maintaining a target sorption capacity.

It has been discovered that the benefits of using a lower molecular weight polyamine as a CO₂ sorbent can be largely maintained while improving the resistance to oxidation and lowering the volatility. This combination of benefits is achieved by reacting the relatively low molecular weight polyamine with a bidentate (or polydentate) linking reagent in a reduced or minimized amount. In some aspects, the amount of multi-dentate linking reagent is selected so that 0.5 mol % to 30 mol % of the nitrogen atoms in the polyamine are reacted during cross-linking, or 1.0 mol % to 30 mol %, or 2.5 mol % to 30 mol %, or 5.0 mol % to 30 mol %, or 0.5 mol % to 15 mol %, or 1.0 mol % to 15 mol %, or 2.5 mol % to 15 mol %, or 5.0 mol % to 15 mol %, or 1.0 mol % to 9.0 mol %, or 2.5 mol % to 9.0 mol %, or 0.5 mol % to 7.5 mol %, or 1.0 mol % to 7.5 mol %, or 2.5 mol % to 7.5 mol %. It is noted that the amount of nitrogen that is reacted during cross-linking is roughly proportional to the amount of multi-dentate linking reagent. It is believed that the linking reagent can allow for linking between polyamine chains as well as linking within a single polyamine chain. The resulting modified polymer can substantially retain the sorption capacity of the lower molecular weight starting polymer material while having reduced volatility and increased resistance to oxidation.

In addition to providing an unexpectedly improved combination of sorption capacity and oxidation resistance, the modified polymer material can also be formed in a relatively straightforward manner. In particular, the polyamine reagent does not need to be reacted or functionalized prior to reacting the polyamine with the linker. In various aspects, the low molecular weight polyamine can correspond to a polymer with an oxygen content of 1.0 wt % or less, or 0.1 wt % or less, such as down to having substantially no oxygen content. Additionally or alternately, the modified polymer material corresponds to a material that can be readily incorporated into/on a solid sorbent, such as a monolith or particles of a refractory oxide and/or zeolite. This can reduce or minimize the difficulties with attempting to build a commercial scale structure that incorporates the sorbent material. Supporting the polymer material can also allow a thin layer to be formed, which can assist with maintaining a higher porosity. This is in contrast to a self-supporting polymer, which typically has a lower porosity in order to maintain structural integrity.

### Definitions

In this discussion, a zeotype is defined to refer to a crystalline material having a porous framework structure built from tetrahedra atoms connected by bridging oxygen atoms. Examples of known zeotype frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, New York (2007) and the corresponding web site, http://www.iza-structure.org/databases/. Under this definition, a zeolite refers specifically to an aluminosilicate having a zeotype framework structure. Under this definition, a zeotype can refer to aluminosilicates (i.e., zeolites) having a zeotype framework structure as well as zeotype framework structures containing oxides of atoms different from silicon and aluminum. Such oxides can include oxides of any other atoms generally known to be suitable for inclusion in a zeotype framework, such as oxides gallium, boron, germanium, phosphorus, zinc, and/or other transition metals that can substitute for silicon and/or aluminum in a zeotype framework. It is noted that under this definition, a zeotype can include materials such as silicoaluminophosphate (SAPO) materials or aluminophosphate (AlPO) materials.

In this discussion, crystalline materials are defined as materials that have an ordered microscopic structure that is capable of diffracting X-rays. Crystalline materials can include, but are not limited to, zeotypes (i.e., materials having a zeotype framework structure) and clays that have sufficient long-range order to be capable of diffracting X-rays. Examples of crystalline zeotypes can include zeolites (materials composed of silicon, aluminum, and oxygen) and SAPOs (materials composed of silicon, aluminum, phosphorus, and oxygen). Examples of atoms different from silicon, aluminum, and oxygen that can be present in a material having a zeotype framework structure include, but are not limited to, Ge, Ga, B, P, and Zn.

In this discussion, a “hierarchical structured zeotype” material is defined as a zeotype material (having a zeotype framework structure) that has at least two levels of pore diameters. A first level of pore diameters corresponds to pores with diameters of less than or equal to 2.0 nm, while the second level of pore diameters corresponds to pores with diameters greater than 2.0 nm. In other words, hierarchical structured zeotypes not only have inherent microporosity, but also have mesoporosity or even macroporosity. Such hierarchical structured materials typically have crystal sizes of less than 1.0 microns. It is noted that although materials such as MCM-41 and MCM-48 have mesoporous channels that are defined as part of the corresponding zeotype framework structure, such materials lack microporosity, and therefore are not inherently within the definition of hierarchical structured zeotype materials.

In this discussion, references to a periodic table are defined as references to the current version of the IUPAC Periodic Table.

In this discussion, the term “polyamine” is defined to include polyamines that include other functional groups, such as polyhydroxylamines or functionalized polyamines. Thus, a modified polyamine that is modified by cross-linking with a cross-linker as described herein also falls within the definition of a polyamine.

### Formation of Modified Polymer

In various aspects, a modified polymer composition can be formed by reacting a low molecular weight polymeric polyamine with a multi-dentate (such as bi-dentate or tri-dentate) linker compound. Formation of the modified polymer can be achieved in any convenient manner. For example, the polyamine can be dissolved in water, ethanol, and/or another suitable solvent to form a solution with a lower viscosity than the neat polyamine. Examples of other solvents include, but are not limited to, methanol and/or other alcohols having a boiling point of 140° C. or less. The multi-dentate linker can then be added to the solution. The solution can be maintained at a reaction temperature, such as 0° C. to 50° C., for a reaction time of 0.1 hours to 10 hours, or 0.1 hours to 2.0 hours to form the modified polymer material. Optionally but preferably, the solution can be stirred or mixed during the reaction time. In some aspects, a support material can then be added to the solution containing the modified polymer material to impregnate the modified polymer on a support. The support material can be contacted with the modified polymer at a temperature of 20° C. to 75° C. for an impregnation time of 0.1 hours to 10 hours, or 0.1 hours to 2.0 hours to form a supported modified polyamine material. The impregnated support material can then be dried to remove the water.

For the low molecular weight polymeric polyamine, a variety of types of polyamine polymers can be suitable. Polyethyleneimine (PEI) is an example of a suitable polyamine. Other types of polyamine polymers (including polyimines) can also be used, such as polyhydroxylamine. Still other examples of polyamines include, but are not limited to, polyvinylamine, polypropyleneimine, polyallylamine, poly(2-dimethylaminoethyl acrylate), poly(2-dimethylaminoethyl methacrylate) and other vinyl polymers. In some aspects, the polyamine can correspond to a functionalized polyamine. Prior to reaction with the multi-dentate linker, the polyamine can correspond to a branched or a non-branched polymer chain.

Generally, the low molecular weight polyamine can have a weight average molecular weight of 500 Da (Daltons) to 15,000 Da, or 500 Da to 10,000 Da, or 500 Da to 5,000 Da, or 500 Da to 2,000 Da, or 500 Da to 1,500 Da. Additionally or alternately, the low molecular weight polyamine can have a number average molecular weight of 500 Da (Daltons) to 5,000 Da, or 500 Da to 2,500 Da, or 500 Da to 1,300 Da, or 500 Da to 1,000 Da. It is noted that for many types of polymers, there is a difference between the number average molecular weight and the weight average molecular weight (i.e., polydispersity). Polydispersity is defined as the ratio of the weight average molecular weight divided by the number average molecular weight. In some aspects, the polydispersity for the polyamine can be 1.5 or less, or 1.4 or less, or 1.3 or less, such as down to 1.0 (i.e., having substantially no polydispersity).

The multi-dentate linker can correspond to a compound that includes functional groups that are suitable for functionalizing an amine. Examples of such compounds include di-epoxies, tri-epoxies, and di-aldehydes. 1,2,7,8 diepoxyoctane (DENO) is an example of a di-epoxy compound that can be used to form a modified polymer material.

In various aspects, the amount of multi-dentate linker in the synthesis solution for forming the modified polymer can correspond to 0.5 wt % to 33 wt % of the combined amount of low molecular weight polyamine and linker in the synthesis solution, or 0.5 wt % to 25 wt %, or 0.5 wt % to 15 wt %, or 0.5 wt % to 10 wt %, or 2.0 wt % to 33 wt %, or 2.0 wt % to 25 wt %, or 2.0 wt % to 15 wt %, or 2.0 wt % to 10 wt %, or 4.0 wt % to 33 wt %, or 4.0 wt % to 25 wt %, or 4.0 wt % to 20 wt %, or 4.0 wt % to 15 wt %, or 4.0 wt % to 10 wt %. Preferably, the amount of multi-dentate linker corresponds to 20 wt % or less of the combined amount of low molecular weight polymine and linker in the synthesis solution, or 15 wt % or less, or 10 wt % or less, such as down to 0.5 wt % or possibly still less. Using such a reduced or minimized amount of the multi-dentate linker can result in reaction of a corresponding reduced or minimized amount of nitrogen atoms in the polyamine, so that the stability benefits are achieved while retaining a high CO₂ capacity in a supported amine material. It is noted that this is a weight percent relative to only the combined amount of polyamine and linker in the synthesis solution; any support material, solvent, and/or other components in the solution are not included in this relative weight percentage. This corresponds to a weight ratio of polyamine to linker in the synthesis solution of roughly 2.0 (i.e., 2.0:1) or more, or 4.0 or more, or 5.0 or more, or 15 or more, or 20 or more, such as up to 200 or possibly still more, or up to 250 or possibly still more. For a comparison on a molar basis, the weight of a monomer of the polyamine can be used as the basis for making a molar comparison with the linker. On a molar basis, the ratio of moles of polyamine monomer to moles of linker can be 5.0 to 1000, or 5.0 to 650, or 5.0 to 350, or 9.0 to 1000, or 9.0 to 650, or 9.0 to 350, or 18 to 1000, or 18 to 650, or 18 to 350, or 30 to 1000, or 30 to 650, or 30 to 350.

In various aspects, due to the nature of the modified polyamine material, the modified polyamine material can be used as a supported modified polyamine material when using the material for sorption/desorption of CO₂. For such a supported modified polyamine material, using a reduced or minimized amount of the multi-dentate linker can result in a supported modified polyamine having an equilibrium CO₂ capacity of 0.5 mmol CO₂/g polyamine or higher at 35° C. in the presence of 100 kPa of CO₂, or 1.5 mmol CO₂/g polyamine or higher, or 2.3 mmol CO₂/g polyamine or higher, or 2.5 mmol CO₂/g polyamine or higher, or 2.7 mmol CO₂/g polyamine or higher, or 3.0 mmol CO₂/g polyamine or higher, such as up to 7.0 mmol CO₂/g polyamine or possibly still higher. Additionally or alternately, in various aspects, the supported modified polyamine material can retain 60% or more of a maximum equilibrium CO₂ capacity after exposure of the supported modified polyamine material to flowing air at 140° C. for 60 minutes in 10 minute intervals, or 65% or more, or 70% or more, or 75% or more, such as up to 85% or possibly still more.

After reacting the low molecular weight (polymeric) polyamine with the multi-dentate linker, the resulting modified polymer material can have an increased molecular weight. In some aspects, the modified polymer material can have a weight average molecular weight be between 1.5 times to 20 times the weight average molecular weight of the polyamine reagent, or 1.5 times to 10 times, or 3.0 times to 20 times. In aspects where the weight average molecular weight of the polyamine reagent is between 500 Da to 1500 Da, the resulting modified polymer material can have a weight average molecular weight of 750 Da to 20,000 Da, or 750 Da to 10,000 Da, or 1500 Da to 20,000 Da, or 1500 Da to 10,000 Da. In such aspects, the polydispersity of the resulting modified polymer material can be between 1.0 to 2.5, or 1.2 to 2.5, or 1.4 to 2.5, or 1.0 to 2.0, or 1.2 to 2.0, or 1.4 to 2.0, or 1.0 to 1.5.

The modified polymer material can also have an unexpectedly high sorption capacity for CO₂ (and/or other potential sorption components) relative to the oxidation resistance of the modified polymer material. Conventionally, lower molecular weight polyamines have improved sorption capacity, but reduced oxidation resistance. It has been discovered that by forming a modified polymer material, the sorption capacity of the underlying low molecular weight polyamine can be substantially retained while providing improved resistance to oxidation. In various aspects, the modified polymer material can have an initial CO₂ sorption capacity that corresponds to 70% or more of the initial sorption capacity of the polyamine reagent, or 80% or more, such as up to 100% or possibly still higher. This sorption capacity can be achieved while reducing or minimizing the loss of sorption capacity over time when the modified polymer material is exposed to the cyclic conditions encountered in a sorption/desorption process.

It is noted that in some aspects, the cross-linked material described herein has a reduced or minimized amount of pore volume (such as substantially no pore volume) unless it is supported on a support material. In such aspects, the cross-linked material described herein, as a self-supported material (such as in the form of particles), can have a pore volume of 25 m²/g or less, or 10 m²/g or less, such as down to substantially no pore volume.

### Support Materials

After forming the modified polymer material, a convenient way to use the modified polymer material for sorption of CO₂ is to coat the material on a support. In some aspects, the support can correspond to a monolith. In other aspects, the support can correspond to particles, such as particles of a refractory oxide and/or a zeolitic support material that provide a large surface area. The modified polymer material can be coated on and/or impregnated into the support material, such as by immersing the support material in a solution containing the modified polymer material. The resulting support that is coated or impregnated with the modified polymer material can then be dried prior to using the supported modified polyamine material as a sorbent for a CO₂ capture process. It is noted that the modified polymer material can potentially be used as a sorbent for other components that are typically sorbed by amine sorbents.

In some aspects, a particulate support material can be used that has various properties, such as a high pore volume, a high ratio of mesopore volume to micropore volume, and/or a sufficient amount of acidity. Such a support material can be crystalline or amorphous.

One property of a support material is a high pore volume. In some aspects, a crystalline support material can have a pore volume of 0.20 g/cm³ or more, or 0.25 g/cm³ or more, or 0.30 g/cm³ or more, or 0.50 g/cm³, such as up to 1.0 g/cm³ or possibly still more. In other aspects, an amorphous support material can have a pore volume of 1.2 g/cm³ or more, or 1.5 g/cm³ or more, such as up to 2.5 g/cm³ or possibly still higher. In this discussion, pore volume is BET pore volume determined according to ASTM D6761. High pore volume can potentially be beneficial for providing additional surface area for the polyamine sorbent. However, conventional attempts to support polyamines on high pore volume supports have taken into account other factors that impact the sorption capacity of the supported polyamine.

In addition to having a sufficient pore volume, a support material can have one or more additional properties. In some aspects, a support material can have an average pore diameter between 5.0 nm and 200 nm, or 5.0 nm to 150 nm, or 5.0 nm to 100 nm, or 5.0 nm to 50 nm, or 10 nm to 200 nm, or 10 nm to 150 nm, or 10 nm to 100 nm, or 10 nm to 50 nm. Average pore diameter is calculated as 4V/A, where V is the BET pore volume and A is the BET total surface area, as determined according to ASTM D6761. Total area is determined according to ASTM D4365. Without being bound by any particular theory, it is believed that larger pore volumes facilitate access of the additional surface area by polyamines.

Another potential consideration is the ratio of mesopore volume to micropore volume. In some aspects, a support material can have a mesopore volume that is equal to or greater than the micropore volume. In such aspects, the ratio of mesopore volume to micropore volume can be 1.0 or more, or 1.2 or more, or 1.5 or more, such as up to 2.5 or possibly still higher. In this discussion, mesopores are defined as pores having a pore diameter of roughly 2 nm to 50 nm. It is noted that ASTM D4365 also provides mesopore volume, which therefore allows for calculation of micropore volume by subtracting the mesopore volume from the total pore volume. Without being bound by any particular theory, it is believed that having a high mesopore volume relative to the micropore volume facilitates allowing the polyamine to enter pores while reducing or minimizing clogging of pores that would restrict sorption capacity.

It is noted that for crystalline materials, mesopore volume can be provided in at least two ways. Some mesopore volume can correspond to mesopores that are defined by the structure of an individual crystallite. In other words, an individual crystal can have one or more pores that are sufficiently large to qualify as mesopores. Other mesopore volume can correspond to mesopores that are defined by the spacing between adjacent crystals. As the size of crystals in a sample is reduced, an increasing amount of mesopore volume can correspond to mesopore volume between crystals that have a hierarchical structure.

Still other factors can be related to the available surface area. Materials with increased surface area can potentially distribute a given amount of an amine sorbent over a larger area, allowing for a thinner layer of amine supported on the material. However, it has been discovered that total surface area alone does not indicate whether a material can provide improved performance for retaining CO₂ sorption capacity when used as a support for a supported amine. Instead, the ratio of external surface area to total surface area is also relevant. In some aspects, a crystalline support material can have a total surface area of 100 m²/g or more, or 200 m²/g or more, such as up to 600 m²/g or possibly still higher. For an amorphous support material, the support material can have a total surface area of 350 m²/g or more, or 400 m²/g or more, or 450 m²/g or more, such as up to 900 m²/g or possibly still higher. Additionally or alternately, a support material can have a ratio of external surface area to total surface area of 0.15 or more, or 0.20 or more, or 0.25 or more, such as up to 0.50 or possibly still higher.

Yet another factor can be the ratio of silicon to aluminum in the support material. Examples of ranges for Si to Al₂ include 10-1000, or 10-300, or 10-150, or 10-100, or 10-49, or 10-30, or 30-1000, or 30-300, or 30-150, or 30-100, or 50-1000, or 50-300, or 50-150. For crystalline materials such as zeolitic materials, the ratio of Si to Al₂ (silica to alumina) in the crystalline material can be 1000 or less, or 300 or less, or 150 or less, or 100 or less, such as down to 10 or possibly still lower. In some aspects, a crystalline support material with a hierarchical structure and/or a crystal sizes too small to resolve with X-ray diffraction can have a Si to Al₂ ratio of 50 or more. For amorphous silica-alumina materials, in some aspects the amorphous silica-alumina can include 20 wt % or more of silica relative to a weight of the amorphous silica-alumina, or 30 wt % or more, such as up to 90 wt %. In some aspects, the amorphous silica-alumina can include 10 wt % or more of alumina, or 20 wt % or more, such as up to 80 wt %. In addition to silica and alumina, the amorphous silica-alumina can include 15 wt % or less of oxides different from silica and alumina, or 10 wt % or less, such as down to being substantially composed of silica and alumina. In other words, the amorphous silica-alumina can have a combined weight of silica and alumina of 85 wt % or more relative to a weight of the amorphous silica-alumina, or 90 wt % or more, such as up to being substantially composed of silica and alumina. In some aspects, a support material (crystalline or amorphous) can consist essentially of oxides of silicon and aluminum, so that less than 1.0 wt % of the material corresponds to atoms different from silicon, aluminum, and oxygen, or less than 0.1 wt %, such as down to no heteroatom content.

Still another factor can be the acidity of a material. In some aspects, a support material can have an acidity, as measured by temperature programmed ammonia desorption (TPAD), of 0.10 meq/g or more, or 0.15 meq/g or more, such as up to 0.50 meq/g or more.

Support materials that can satisfy a plurality of the above properties may or may not have an X-ray diffraction (XRD) pattern that shows long range order and/or crystallinity. Some materials may correspond to crystalline zeotype materials (such as zeolitic materials) that have a zeotype framework structure. Other materials may correspond to small crystal zeotype materials and/or hierarchical materials that have broadened XRD patterns due to small crystal size.

In some aspects, the support material can correspond to a zeotype material (i.e., a material having a zeotype framework structure). In such aspects, the zeotype material can have a pore network so that a diffusing sphere of 5.0 Angstroms or larger can pass through the pore network, such as up to 10 Angstroms or possibly still larger. Additionally or alternately, the zeotype material can have largest pore channel having a ring size corresponding to a 10-member ring or larger, such as up to a ring size corresponding to a 16-member ring. Further additionally or alternately, the zeotype material can have pore volume of 0.2 cm³/g or more, such as up to 0.5 cm³/g or possibly still more. Still further additionally or alternately, the zeotype material can have a ratio of mesopore volume to micropore volume of 1.0 or more, such as up to 2.5. Such a zeotype material may optionally not have substantial Bronsted acidity.

Support materials that can have a plurality of the above characteristics, such as three or more, or four or more, and up to substantially all of the above characteristics, include crystalline materials (such as zeotype materials), as well as small crystal/hierarchical versions of crystalline materials. Examples of crystalline materials having zeotype framework structure that can have combinations of the above properties include EMM-57, EMM-72 (SFN), EMM-34 (MOR), EMM-20 and/or ZSM-5 (MFI), UTD-1 (DON) and EMM-30 and/or ZSM-11. Examples of zeotype materials that can have combinations of the above characteristics in small crystal/hierarchical versions include zeolite Beta (BEA), mordenite (MOR), ZSM-12 (MTW), ZSM-5 (MFI), UTD-1 (DON), ZSM-23 (MTT), and ZSM-57 (MFS).

### Conditions for Sorption/Desorption Cycle

In various aspects, a modified polymer material, optionally supported on a support material, can be used in a process for selectively sorbing a component from a fluid phase flow, and then desorbing the sorbed component to perform a cyclic sorption/desorption process. In some aspects, CO₂ can be the component that is selectively sorbed and desorbed. In other aspects, any other convenient component which can undergo chemisorption and/or adsorption at amine sites can be the component that is selectively sorbed and desorbed.

An example of a component that can be sorbed/desorbed is CO₂. One option for performing a CO₂ sorption/desorption cycle is to use temperature to facilitate sorption and then desorption of the CO₂. For example, a sorbent material can be exposed to CO₂ at a lower temperature in order to sorb CO₂, followed by increasing the temperature of the material to desorb the CO₂.

In some aspects, sorption of CO₂ can be performed by exposing the modified polymer material to CO₂ at a temperature between 0° C. and 70° C., or 15° C. to 70° C., or 0° C. to 50° C., or 15° C. to 50° C. During sorption, the modified polymer is exposed to a fluid (typically gas phase) stream containing multiple components, with one of the components corresponding to CO₂. The CO₂ concentration in the fluid stream can vary widely depending on the application. In some aspects such as a direct air capture system, the CO₂ concentration can be relatively low, such as a CO₂ concentration of 100 vppm to 1000 vppm, or 100 vppm to 600 vppm. In other aspects, the fluid stream can have higher CO₂ concentration, such as a CO₂ concentration of 0.1 vol % to 10 vol %, or possibly still higher. The total pressure during the sorption step can range from 70 kPa-a to 10,000 kPa-a, or 70 kPa-a to 5,000 kPa-a, or 70 kPa-a to 1,000 kPa-a, or 100 kPa-a to 10,000 kPa-a, or 100 kPa-a to 5,000 kPa-a, or 100 kPa-a to 1,000 kPa-a.

After a sorption step, a different set of conditions can be used for desorption. In a temperature swing cycle, desorption can be facilitated by increasing the temperature of the sorbent environment. Optionally, the pressure can also be decreased. In some aspects, desorption of CO₂ can be performed at a temperature of 70° C. to 200° C., or 70° C. to 170° C., or 70° C. to 140° C., or 90° C. to 200° C., or 90° C. to 170° C., or 90° C. to 140° C., or 110° C. to 200° C., or 110° C. to 170° C. Optionally, the temperature during desorption can be greater than the temperature during sorption by 30° C. or more, or 50° C. or more, such as up to 110° C. or possibly still more. The total pressure during the sorption step can range from 70 kPa-a to 10,000 kPa-a, or 70 kPa-a to 5,000 kPa-a, or 70 kPa-a to 1,000 kPa-a, or 100 kPa-a to 10,000 kPa-a, or 100 kPa-a to 5,000 kPa-a, or 100 kPa-a to 1,000 kPa-a. Optionally, the pressure during desorption can be similar to the pressure during sorption. Optionally, the pressure during desorption can be lower than the pressure during sorption by 20 kPa or more, or 50 kPa or more, or 100 kPa or more, such as up to 8000 kPa or possibly still more. In some aspects, a sweep fluid can be passed over and/or through the sorbent environment during desorption to assist with removing the desorbed CO₂.

### EXAMPLES

In the following examples, two types of supported amine-based polymers are tested for CO₂ sorption/desorption properties, volatility, and oxidative stability.

One type of supported polymer system (Comparative Example A) corresponds to polyethyleneimine (PEI) supported on a particulate support material. Materials corresponding to Comparative Example A were formed by diluting PEI in either water or ethanol to make a low viscosity solution. A powder of high surface area support material was then added to the solution and mixed at 50° C. for 24 hrs, followed by drying under nitrogen atmosphere to produce Comparative Example A.

The other type of supported polymer system (Example B) corresponded to a modified polymer material impregnated on the same type of support. Materials corresponding to Sample B were formed by diluting PEI in ethanol to make a low viscosity solution. Next, 1,2,7,8 diepoxyoctane (DENO) was added to the PEI/EtOH solution at ambient temperature (roughly 20° C.) and stirred for 30 minutes. Over this time, the DENO and the PEI reacted to form a modified polymer material with higher molecular weight. After 30 minutes, the powder of high surface area support material was added to the solution and mixed at 50° C. for 24 hrs, followed by drying under nitrogen atmosphere to produce Sample B.

In some of the Examples below, EMM-57 is used as a support material. The EMM-57 is synthesized according to the following method. Examples of this zeolite are described in U.S. Pat. No. 10,807,875. An exemplary synthesis of EMM-57 is illustrated below but is not limiting. Variations in Si/Al₂ of the final product, silica source, alumina source, and the addition of other cations to the synthesis can contribute to controlling the EMM-57 support acidity, morphology, crystal size, aggregate size, and agglomerate size. As a synthesis example, add 8587.0 g of 10 wt % 1,2,3-trimethyl-1H-benzo[d]imidazol-3-ium hydroxide to 5276.7 g of water. Add 38.2 g of dried aluminum hydroxide gel and 13.5 g of EMM-57 seeds to the hydroxide solution. Add 1084.4 g of precipitated silica to the aluminate solution and stir the mixture for 45 minutes to create a homogeneous slurry. Heat the slurry in a stirred autoclave for 60-96 hours at 170° C. Isolate the crystal via vacuum filtration, wash with 2 volumes of water, and dry the filter cake. The powder XRD of the resulting product is EMM-57.

### Example 1—CO₂ Capacity

The two types of materials were tested for CO₂ capacity. Table 1 shows the relative amounts of PEI, support, and DENO (if any) that were used to make the various samples. Table 1 also shows the amount of CO₂ uptake in millimoles of CO₂ per gram of either PEI or PEI plus support. It is noted that for the samples including DENO, the DENO is not included in the calculation of CO₂ capacity when using units of mmol/g PEI.

The CO₂ capacity values were determined by thermogravimetric analysis (TGA). To determine CO₂ capacity, samples were first exposed to a purge procedure. The samples were initially ramped to 110° C. at roughly 10° C. per minute under 1 atm (˜100 kPa-a) of nitrogen. The samples were held at 110° C. for roughly 4 hours. The samples were then cooled under nitrogen at roughly 10° C. per minute to reach a temperature of 35° C. The samples were held at 35° C. under the nitrogen for roughly 30 minutes. The gas phase environment was then replaced with 1 atm (˜100 kPa-a) of CO₂. The samples were held at 35° C. under the CO₂ for roughly 3 hours. The weight of the sample was monitored using the TGA device during these steps in order to characterize the CO₂ capacity.

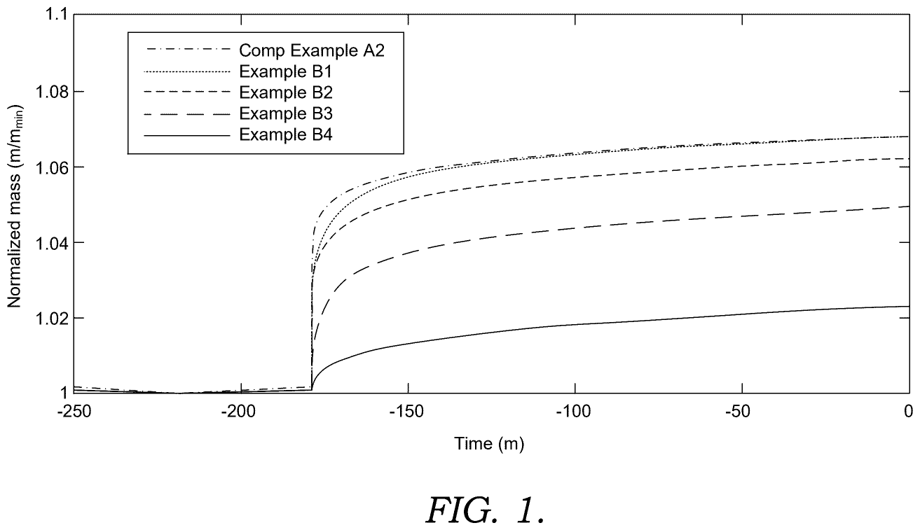

As shown in Table 1, addition of low levels of DENO to form a modified polymer material results in a modified polymer material with comparable levels of CO₂ capacity to the unmodified PEI. Thus, the modified polymer material had similar CO₂ capacity to unmodified PEI at weight ratios of PEI to DENO of roughly 10 or more (molar ratio of PEI monomer units to DENO of roughly 30 or more, as defined herein). At lower ratios of PEI to DENO (weight ratio less than 9.0, molar ratio less than roughly 30), however, the CO₂ capacity started to drop. This drop becomes more pronounced at weight ratios of PEI to DENO lower than 4.0 (molar ratio less than roughly 13). FIG. 1 shows the thermogravimetric analysis (TGA) results corresponding to the capacities shown in Table 1.

TABLE 1
Samples and CO₂ Capacities

| | | | | | | | | CO2 |
|---|---|---|---|---|---|---|---|---|
| | | | | | | DENO | CO2 | capacity |
| | Impreg | PEI | Support | DENO | PEI | (wt. | capacity | (mmol/g |
| Example | T (C.) | (g) | (g) | (g) | (wt. %) | %) | (mmol/g) | PEI) |
| Comp. | 50 | 3 | 3 | 0 | 50 | 0 | 1.8 | 3.6 |
| Example A1 | | | | | | | | |
| Comp. | 50 | 3 | 3 | 0 | 50 | 0 | 1.5 | 3.1 |
| Example A2 | | | | | | | | |
| Example B1 | 50 | 0.996 | 1.02 | 0.05 | 48.2 | 2.4 | 1.5 | 3.2 |
| Example B2 | 50 | 1.02 | 1.03 | 0.099 | 47.5 | 4.6 | 1.4 | 3.0 |
| Example B3 | 50 | 1.008 | 1.05 | 0.205 | 44.5 | 9.1 | 1.1 | 2.5 |
| Example B4 | 50 | 1.011 | 1 | 0.398 | 42.0 | 16.5 | 0.5 | 1.2 |

### Example 2—Volatility and Thermal Stability

Differential thermal analysis (DTA) was used to characterize the volatility and oxidative stability of the various samples. The DTA was performed in the same apparatus used for the TGA analysis in Example 1. To investigate volatility, samples corresponding to Examples A2, B1, B2, B3, and B4 were each ramped to 140° C. at a rate of 5° C. per minute under nitrogen. The samples were then held at 140° C. for roughly 4 hours to measure the mass loss (volatility) due to exposure to 140° C. for an extended period. At the end of the roughly 4 hours, the gas phase environment for the samples was switched to air. The samples were then held at 140° C. for roughly another 4 hours to determine mass loss due to formation of volatile compounds via oxidation.

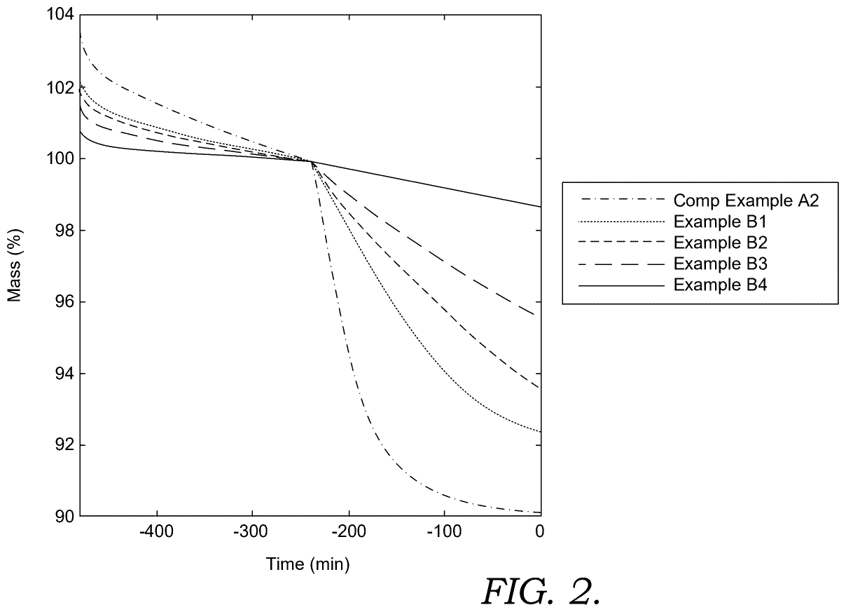

FIG. 2 shows the results from the DTA runs. In FIG. 2, the weight of each sample was normalized so that the weight at the end of the N₂ exposure at 140° C. corresponds to 100% mass. The end of the N₂ exposure at 140° C. is assigned a time of 0 minutes in FIG. 2. Thus, times prior to 0 minutes correspond to the change in mass due to volatility of the polymer, while times after 0 minutes correspond to the change in mass due to oxidation of polymer to volatile compounds.

As shown in FIG. 2, the modified polymer materials have a decrease in volatility and increase in oxidation resistance that is roughly proportional to the amount of linker used to make the modified polymer. As noted in Example 1, however, the change in CO₂ capacity was not linear with increase in the amount of linker in the modified polymer material. Instead, use of sufficiently low amounts of linker resulted in a modified polymer material with substantially the same CO₂ capacity as the unmodified PEI. Thus, the combination of FIG. 1 and FIG. 2 illustrate the unexpected nature of the modified polymer materials when the amount of linker is sufficiently low. A benefit of improved oxidation resistance and lowered volatility is achieved for the modified polymer while substantially retaining the CO₂ capacity of the unmodified polymer.

It is noted that the reduced volatility benefits shown in FIG. 2 will be mitigated as the weight average molecular weight of the initial polyamine reagent is increased. However, it is believed the oxidative resistance benefits are retained, independent of the polymer size of the initial polyamine reagent.

### Example 3—Cyclical Exposure to Oxidizing and Sorption Environments

To further illustrate the benefits of the modified polymer materials with regard to improving material lifetime (e.g., slowing down oxidative degradation that retards CO₂ adsorption), cyclical oxidation/CO₂ uptake tests were performed. In this example, the CO₂ capacity of a sample corresponding to Example A1 was compared with a sample corresponding to Example B2 after cyclic exposure to air at temperatures of either 120° C. or 140° C.

The cyclic process was performed using the TGA unit. The cyclic process of oxidation, CO₂ sorption, and CO₂ desorption was performed as follows. First, to prepare a sample, the sample was ramped at 10° C./min to 140° C. under N₂. The sample was then held at 140° C. for roughly 180 minutes under N₂ to desorb any CO₂ or H₂O. The sample was then cooled at 10° C./min to 35° C. After reaching 35° C., the gas phase environment was switched to CO₂. The temperature was maintained at 35° C. in the presence of the CO₂ for roughly 30 minutes to measure a baseline CO₂ capacity. The gas phase environment was then purged with N₂.

At this point, the cyclic process was started. First, the temperature of the sample was ramped to either 120° C. or 140° C. at 10° C./min under the N₂ gas phase environment. The gas phase environment was then switched to air. The temperature of either 120° C. or 140° C. was maintained for roughly 10 minutes in the presence of the air gas phase environment. The gas phase environment was then purged with N₂. Next, the temperature was ramped down to 35° C. at 10° C./min. The gas phase environment was then switched to CO₂, and the sample was held at 35° C. for roughly 30 minutes in the presence of the CO₂ gas phase environment to measure a new CO₂ capacity. The process was then repeated to measure how cyclic oxidation impacted CO₂ capacity over time.

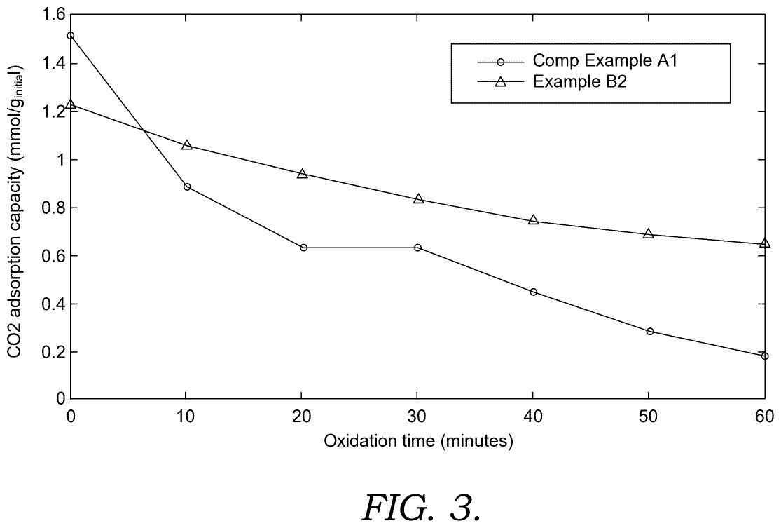

FIG. 3 shows the CO₂ capacity results from cyclic exposure of the A1 (Comparative) and B2 (modified polymer material) samples at 140° C. during the oxidation step. As shown in FIG. 3, the modified polymer material initially provided comparable CO₂ capacity to the unmodified PEI. Over time, the modified polymer material retained a substantial portion of the initial CO₂ capacity. By contrast, the unmodified PEI sample rapidly dropped to having less than half of the initial CO₂ capacity, and continued to lose additional CO₂ capacity at longer times.

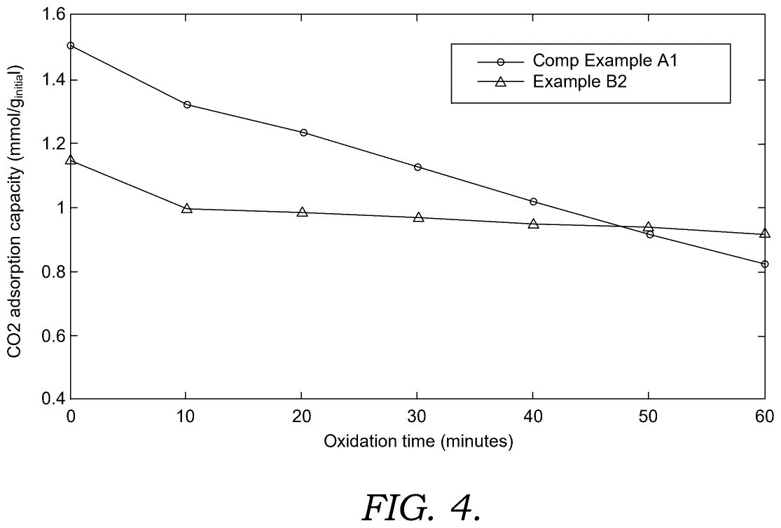

FIG. 4 shows the CO₂ capacity results from cyclic exposure at 120° C. during the oxidation step. As shown in FIG. 4, the degradation of the unmodified PEI is slower, but the modified polymer material still provides a substantial advantage in retaining the initial level of CO₂ capacity.

### Example 4—Additional Kinetic and Capacity Characterization

An additional unexpected finding was that using relatively low amounts of a linking agent to form a modified polymer resulted in a modified polymer that had sorption kinetics that were comparable to the unmodified polymer. This was determined based on additional characterization of the samples described in Table 1. This additional characterization corresponded to “breakthrough” characterization.

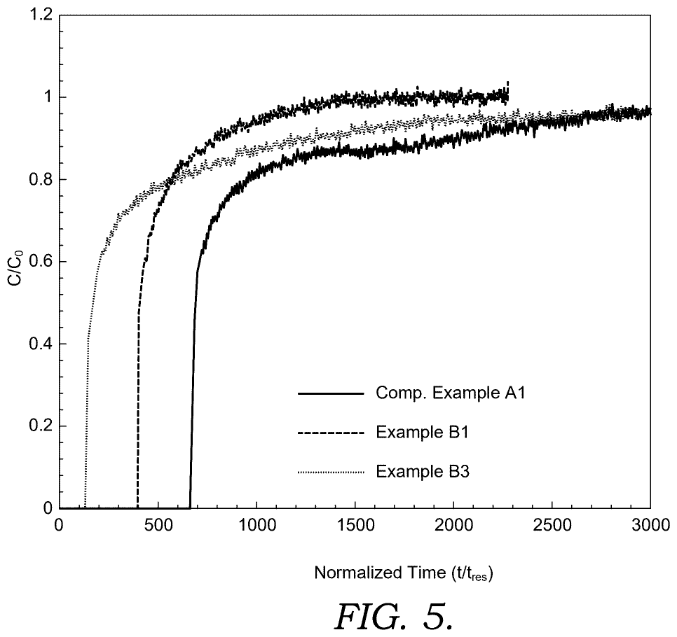

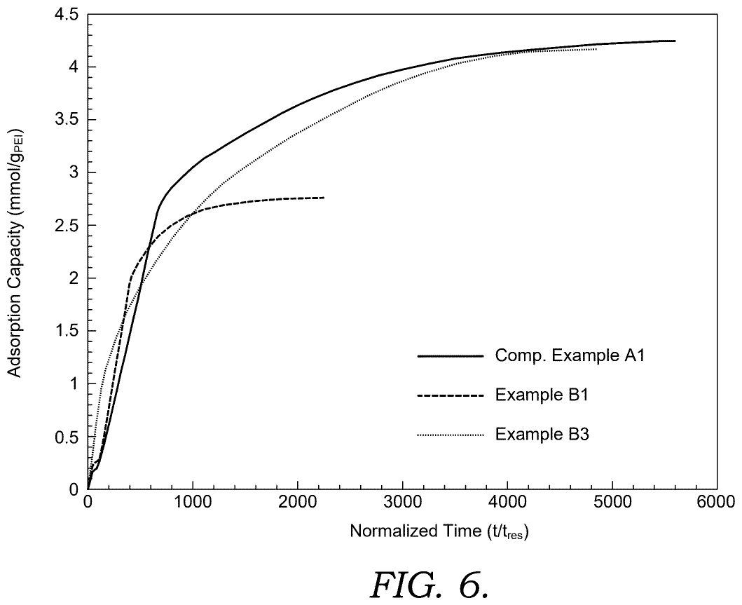

For this additional characterization, all samples were sieved to 425-250 microns. The samples were then packed into a column and heated under a flow of 100 sccm N₂ to 100° C. for 16 hours. The samples were then placed on a breakthrough test unit with high-speed switching valves. A stream of 8333 ppm CO₂ in N₂ was delivered to the packed bed maintained at 30° C. in a furnace. The effluent gas stream was measured via mass spectrometry (see FIG. 5). An in-line flow meter was used to convert the breakthrough curve to an adsorption curve (see FIG. 6).

As shown in FIG. 5 and FIG. 6, Comparative Example A1 from Table 1 (unmodified PEI) exhibited a larger capacity (FIG. 5) with a substantial contribution from fast CO₂ adsorption kinetics (FIG. 6). Modified PEI Example B1 had a smaller overall capacity (FIG. 5), but exhibited similarly fast kinetics (FIG. 6) compared to Comparative Example A1. Thus, even though some capacity was lost, the resulting modified polymer unexpectedly had sorption kinetics similar to an unmodified polymer. Example B3 had larger overall capacities (FIG. 5) comparable to Comparative Example A1, but a larger component of that capacity corresponded to slow kinetics (FIG. 6) as indicated by a slow approach to the original CO₂ concentration of the feed.

### Example 5—NMR Quantification of Amines

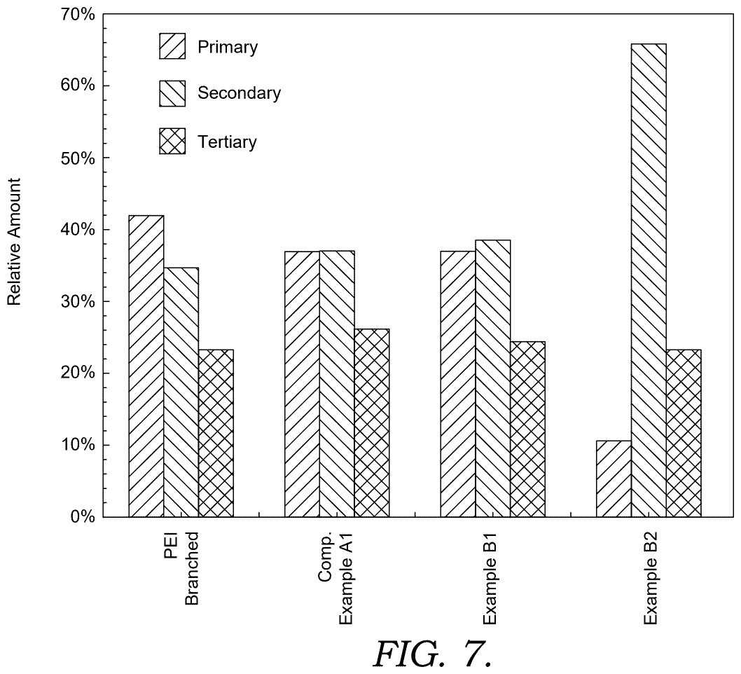

The types of amines present in the unmodified and modified PEI samples were characterized using nuclear magnetic resonance (NMR) spectroscopy. FIG. 7 shows a plot summarizing the quantification of the primary, secondary, and tertiary amines of the neat PEI, supported PEI (Comp. Example A1), and select modified PEI samples (Example B1 and Example B2). To perform this analysis, samples were prepared by sonicating a slurry of powdered PEI/support in a solution of deuterated chloroform. The samples were then filtered and prepared for ¹³C NMR measurements. The primary, secondary, and tertiary amines were quantified using assignments published by Choi et al (Nat. Commun. 7:12640 doi: 10.1038/ncomms12640 (2016)). FIG. 7 shows that the epoxidation of the sample selectively occurs on the primary amines to create additional secondary amines under these reaction conditions. It is noted that the quantity of tertiary amines is relatively constant in all samples.

### Example 6—Cross-Linked Amines and CO₂ Capacity

By using NMR quantification, the percentage of amines in a polyamine sample that participate in cross-linking can be quantified. This procedure is described in an article by Choi et al., (Nat. Commun. 7:12640 doi: 10.1038/ncomms12640 (2016)). Briefly, a sample of the polyamine prior to reaction (such as unmodified PEI) can be characterized using ¹³C-NMR to characterize the number of primary, secondary, and tertiary amines in the sample. A sample after cross-linking (such as modified PEI) can then be characterized in a similar manner. By characterizing the change in the number of primary, secondary, and tertiary amines before and after modification, the degree of cross-linking can be determined.

It has been discovered that the benefits of cross-linking the polyamine can be achieved at a relatively low level of cross-linking. By performing a reduced or minimized amount of cross-linking, the unexpected combination of increasing stability while preserving CO₂ capacity can be achieved.

A series of supported amines were prepared by forming cross-linked polyethyleneimine (PEI) on EMM-57. The cross-linking agent was 1,2,7,8-diepoxyoctane (DENO). Table 2 shows characterization of the cross-linked PEI, including the relative amounts of PEI, EMM-57, and DENO used to form the supported cross-linked amine composition and the resulting CO₂ capacities.

TABLE 2
CO2 Capacity of Cross-Linked PEI

| % N in | | | | CO2 | CO2 |
|---|---|---|---|---|---|
| PEI | PEI | EMM-57 | DENO | capacity | capacity |
| reacted | (wt %) | (wt %) | (wt %) | (mmol/g) | (mmol/g PEI) |
| 3% | 48.21 | 49.37 | 2.42 | 1.54 | 3.20 |
| 6% | 47.46 | 47.93 | 4.61 | 1.41 | 2.98 |
| 12% | 44.54 | 46.40 | 9.06 | 1.12 | 2.51 |
| 24% | 41.97 | 41.51 | 16.52 | 0.52 | 1.24 |

As shown in Table 2, the percentage of N atoms reacted in the PEI increases roughly linearly with the amount of cross-linking agent. When the percentage of N atoms in the polyamine that are reacted during cross-linking is greater than 9.0 mol %, the CO₂ capacity of the resulting supported amine drops dramatically. increasing the amount of DENO relative to the amount of PEI (or other amine) results in an increase in the percentage of nitrogens in the PEI that are reacted. Table 3 shows characterization of additional supported amine samples based on PEI, EMM-57, and optionally DENO as a cross-linking agent.

TABLE 3
Characterization of Additional Samples

| EMM-57 | DENO | PEI | DENO | Epoxy/amine | CO2 capacity | CO2 capacity | |
|---|---|---|---|---|---|---|---|
| (wt %) | (wt %) | (mmol) | (mmol) | (%) | (mmol/g) | (mmol/g PEI) | |
| 50 | 0 | ~23 | 0 | N/A | 1.8 | 3.7 | 3.6 |
| 50 | 0 | ~23 | 0 | N/A | 1.9 | 3.9 | |
| 50 | 0 | ~23 | 0 | N/A | 1.8 | 3.6 | |
| 50 | 0 | ~23 | 0 | N/A | 1.5 | 3.1 | |
| 49.4 | 2.4 | 23.1 | 0.4 | 3.0 | 1.5 | 3.2 | |
| 47.9 | 4.6 | 23.7 | 0.7 | 5.9 | 1.4 | 3.0 | |
| 46.4 | 9.1 | 23.4 | 1.4 | 12.3 | 1.1 | 2.5 | |
| 41.5 | 16.5 | 23.5 | 2.8 | 23.9 | 0.5 | 1.2 | |

In Table 3, all of the samples include roughly the same amount of PEI supported on roughly the same amount of EMM-57. The only difference is that some samples are cross-linked with various amounts of DENO. As shown in Table 3, the PEI samples without cross-linker have an average CO₂ capacity of 3.6 mmol CO₂/g PEI. When less than 7.6 wt % of DENO is included as a cross-linker, the CO₂ capacity remains above 2.8 mmol CO₂/g PEI. However, further increases in the amount of PEI result in a sharp drop in CO₂ capacity.

Table 4 shows characterization of additional supported amine samples based on PEI, Siral-40HPV, and optionally DENO as a cross-linking agent.

TABLE 4
Characterization of Additional Samples with Siral 40HPV

| Siral | | | | | | |
|---|---|---|---|---|---|---|
| 40HPV | DENO | PEI | DENO | Epoxy/ami | CO2 capacity | CO2 capacity |
| (wt %) | (wt %) | (mmol) | (mmol) | ne (%) | (mmol/g) | (mmol/g PEI) |
| 55.2 | 7.5 | .016 | .002 | 12 | 1.44 | 3.86 |
| 57.6 | 3.9 | .016 | .001 | 6 | 2.00 | 5.18 |

In Table 5, oxidation experiments were conducted where CO₂ was first adsorbed at 35° C. (0 min in Table 5), then nitrogen was passed over the sample while heating to 140° C., followed by air flow for 10 minutes. This was repeated 6 times to give 60 total minutes of air oxidation at 140° C., where CO₂ capacity was measured after each 10 minute oxidation step. Table 5 shows the results, where normalized CO₂ capacity is listed at 20 minute intervals.

TABLE 5
Characterization of Additional Samples with EMM-57

| EMM-57 | PEI | DENO | Normalized CO2 capacity (mmol CO2/g) | | | |
|---|---|---|---|---|---|---|
| (wt. %) | (wt. %) | (wt. %) | 0 min | 20 min | 40 min | 60 min |
| 47.6 | 47.6 | 4.8 | 1.00 | 0.83 | 0.73 | 0.70 |
| 49.6 | 49.5 | 1.0 | 1.00 | 0.67 | 0.58 | 0.40 |
| 49.8 | 49.7 | 0.5 | 1.00 | 0.61 | 0.49 | 0.25 |

### ADDITIONAL EMBODIMENTS

Embodiment 1. A supported modified polyamine material, formed by the process comprising: mixing a polyamine comprising a weight average molecular weight of 500 Da to 5,000 Da with a multi-dentate linker comprising a plurality of epoxy groups, aldehyde groups, halide groups, isocyanate groups, or a combination thereof, in a solvent to form a modified polymer material, the polyamine and multi-dentate linker being mixed in a molar ratio of monomer units of polyamine to multi-dentate linker of between 5.0 and 1000, and supporting the modified polyamine material on a porous support to form a supported modified polyamine material, wherein the supported modified polyamine material comprises an equilibrium CO₂ capacity of 0.5 mmol CO₂/g polyamine or higher at 35° C. in the presence of 100 kPa CO₂.

Embodiment 2. The supported modified polyamine material of Embodiment 1, wherein the polyamine comprises nitrogen atoms, and wherein 30.0 mol % or less of the nitrogen atoms in the polyamine are reacted during the cross-linking.

Embodiment 3. The supported modified polyamine material of any of the above embodiments, wherein the supported modified polyamine material retains 70% of the equilibrium CO₂ capacity after exposure of the supported modified polyamine material to flowing air at 140° C. for 60 minutes.

Embodiment 4. The supported modified polyamine material of any of the above embodiments, wherein the porous support comprises a pore volume of 0.2 cm³/g to 2.5 cm³/g.

Embodiment 5. The supported modified polyamine material of Embodiment 4, i) wherein the porous support comprises a crystalline porous support having a pore volume of 0.2 cm³/g to 1.0 cm³/g; ii) wherein the porous support comprises an amorphous porous support having a pore volume of 1.2 cm³/g to 2.5 cm³/g; iii) wherein the porous support comprises a surface area of 100 m²/g or more; or iv) a combination of two or more of i), ii), and iii).

Embodiment 6. The supported modified polyamine material of any of the above embodiments, wherein the porous support comprises particles of support material, or wherein the porous support comprises a monolith.

Embodiment 7. The supported modified polyamine material of any of the above embodiments, wherein the process further comprises drying the supported modified polyamine material.

Embodiment 8. The supported modified polyamine material of any of the above embodiments, wherein the porous support comprises a refractory oxide, a zeotype, or a combination thereof.

Embodiment 9. The supported modified polyamine material of any of the above embodiments, wherein the porous support comprises oxides of silicon and aluminum, the porous support optionally further comprising oxides of one or more of gallium, germanium, zinc, phosphorus, and boron.

Embodiment 10. The supported modified polyamine material of any of the above embodiments, wherein supporting the modified polyamine material comprises impregnating the porous support with the modified polymer material.

Embodiment 11. The supported modified polyamine material of any of the above embodiments, a) wherein the polyamine comprises a polydispersity of 1.5 or less; b) wherein the polyamine comprises 1.0 wt % or less of oxygen; c) wherein the polyamine comprises a number average molecular weight of 500 Da to 1,300 Da; or d) a combination of two or more of a), b), and c).

Embodiment 12. The supported modified polyamine material of any of the above embodiments, wherein the solvent is ethanol, methanol, water, an alcohol with a boiling point of 140° C. or less, or a combination thereof.

Embodiment 13. The supported modified polyamine material of any of the above embodiments, wherein the supported modified polyamine material comprises an equilibrium CO₂ capacity of 2.3 mmol CO₂/g polyamine or higher at 35° C. in the presence of 100 kPa CO₂.

Embodiment 14. The supported modified polyamine material of any of the above embodiments, wherein a molar ratio of polyamine to multi-dentate linker being mixed is 0.5 to 50, the molar ratio being determined based on the weight average molecular weight of the polyamine; or wherein the amount of multi-dentate linker mixed with the polyamine comprises 0.5 wt % to 20 wt % of a combined weight of the multi-dentate linker and the polyamine; or a combination thereof.

Embodiment 15. The supported modified polyamine material of any of the above embodiments, I) wherein the polyamine comprises polyethyleneimine; II) wherein the polyamine comprises a branched polyamine; III) wherein the polyamine comprises polypropyleneimine, polyhydroxylamine; IV) wherein the polyamine comprises a functionalized polyamine; V) a combination of two or more of I), II), III), and IV); or VI) a combination of three or more of I), II), III), and IV).

Additional Embodiment A. The supported modified polyamine material of any of the above embodiments, further comprising drying the supported modified polyamine material.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A supported modified polyamine material, formed by the process comprising:
mixing a polyamine comprising a weight average molecular weight of 500 Da to 5,000 Da with a multi-dentate linker comprising a plurality of epoxy groups, aldehyde groups, halide groups, isocyanate groups, or a combination thereof, in a solvent to form a modified polymer material, the polyamine and multi-dentate linker being mixed in a molar ratio of monomer units of polyamine to multi-dentate linker of between 5.0 and 1000, and
supporting the modified polyamine material on a porous support to form a supported modified polyamine material,
wherein the supported modified polyamine material comprises an equilibrium CO₂ capacity of 0.5 mmol CO₂/g polyamine or higher at 35° C. in the presence of 100 kPa CO₂.

2. The supported modified polyamine material of claim 1, wherein the supported modified polyamine material comprises an equilibrium CO₂ capacity of 2.3 mmol CO₂/g polyamine or higher at 35° C. in the presence of 100 kPa CO₂.

3. The supported modified polyamine material of claim 1, wherein the polyamine comprises nitrogen atoms, and wherein 30.0 mol % or less of the nitrogen atoms in the polyamine are reacted during the cross-linking.

4. The supported modified polyamine material of claim 1, wherein the supported modified polyamine material retains 70% of the equilibrium CO₂ capacity after exposure of the supported modified polyamine material to flowing air at 140° C. for 60 minutes.

5. The supported modified polyamine material of claim 1, wherein the porous support comprises a pore volume of 0.2 cm³/g to 2.5 cm³/g.

6. The supported modified polyamine material of claim 5, wherein the porous support comprises a crystalline porous support having a pore volume of 0.2 cm³/g to 1.0 cm³/g.

7. The supported modified polyamine material of claim 5, wherein the porous support comprises an amorphous porous support having a pore volume of 1.2 cm³/g to 2.5 cm³/g.

8. The supported modified polyamine material of claim 1, wherein the porous support comprises particles of support material, or wherein the porous support comprises a monolith.

9. The supported modified polyamine material of claim 1, wherein the porous support comprises a surface area of 100 m²/g or more.

10. The supported modified polyamine material of claim 1, wherein the process further comprises drying the supported modified polyamine material.

11. The supported modified polyamine material of claim 1, wherein the porous support comprises a refractory oxide, a zeotype, or a combination thereof.

12. The supported modified polyamine material of claim 1, wherein the porous support comprises oxides of silicon and aluminum.

13. The supported modified polyamine material of claim 12, wherein the porous support further comprises oxides of one or more of gallium, germanium, zinc, phosphorus, and boron.

14. The supported modified polyamine material of claim 1, wherein supporting the modified polyamine material comprises impregnating the porous support with the modified polymer material.

15. The supported modified polyamine material of claim 1, wherein the polyamine comprises a polydispersity of 1.5 or less.

16. The supported modified polyamine material of claim 1, wherein the polyamine comprises 1.0 wt % or less of oxygen.

17. The supported modified polyamine material of claim 1, wherein the polyamine comprises a number average molecular weight of 500 Da to 1,300 Da.

18. The supported modified polyamine material of claim 1, wherein the solvent is ethanol, methanol, water, an alcohol with a boiling point of 140° C. or less, or a combination thereof.

19. The supported modified polyamine material of claim 1, further comprising drying the supported modified polyamine material.

20. The supported modified polyamine material of claim 1, wherein a molar ratio of polyamine to multi-dentate linker being mixed is 0.5 to 50, the molar ratio being determined based on the weight average molecular weight of the polyamine.

21. The supported modified polyamine material of claim 1, wherein the amount of multi-dentate linker mixed with the polyamine comprises 0.5 wt % to 20 wt % of a combined weight of the multi-dentate linker and the polyamine.

22. The supported modified polyamine material of claim 1, wherein the polyamine comprises polyethyleneimine.

23. The supported modified polyamine material of claim 1, wherein the polyamine comprises a branched polyamine.

24. The supported modified polyamine material of claim 1, wherein the polyamine comprises polypropyleneimine, polyhydroxylamine, or a combination thereof.

25. The supported modified polyamine material of claim 1, wherein the polyamine comprises a functionalized polyamine.
